(19) United States
(12) Patent Application Publication
(10) Pub. No.: US 2003/0127236 A1
(43) Pub. Date: Jul. 10, 2003

(54) Wedge shaped planting tool

(76) Inventor: Helen R. Wherry, Chicago, IL (US)

Correspondence Address: William P. Oberhardt, Roper & Quigg, 200 South Michigan Avenue, Suite 1000, Chicago, IL, 60604, US

(21) Appl. No.: 10/338,406

(22) Filed: Jan. 8, 2003

Related U.S. Application Data
(60) Provisional application No. 60/346,932, filed on Jan. 9, 2002.

(51) Int. Cl. A01B 1/00

(52) U.S. Cl. 172/371

(57) ABSTRACT

A hand-held gardening tool including a wedge shaped portion and a handle preferably having a substantially knob shape. The handle is shaped so as to allow the user to grip the handle with the palm and fingers of a hand and use the invention while simultaneously minimizing wrist and hand strain. The wedge shaped portion is shaped so as to allow the user to insert the wedge shaped portion into soil, the thin blade portion being inserted first. After insertion, the invention is rocked back and forth and/or side to side to create a space for a plant to be planted by displacing, rather than removing, the soil. The gardening tool of the invention allows plants to be planted with minimal damage to any surrounding root systems or plants and minimal soil removal, in less time and with less mess than traditional planting methods.

### BACKGROUND OF THE INVENTION

1. Field of the Invention

This invention relates generally to gardening tools, and, in particular, hand held gardening tools to be used for planting.

2. Brief Description of the Prior Art

Currently, hand-held gardening tools include hand-held devices such as trowels which tend to have a generally cylindrically shaped slim handle attached to a curved digging portion. The curved shape of the digging portion of current hand-held gardening tools allows the user to cut into the soil, and thereafter, to scoop out the soil, removing it and any other items in the soil, such as roots from surrounding plants, to make a hole for the object to be planted. The soil and other items thus removed must then be deposited somewhere, such as beside the hole, in a wheelbarrow, or the like.

One disadvantage to current hand-held gardening tools is that the shape of the handle requires the user to grip the handle from the side and use an upwardly twisting wrist motion when scooping out soil which often causes the hand and the wrist to quickly fatigue from the amount of pressure to the wrist. Another drawback of current hand-held gardening tools is that current hand-held gardening tools for displacing soil involve removing the soil and often placing it around the newly dug hole, or placing it in another location such as a wheelbarrow, which either disturbs a larger area than is necessary with the current invention, or requires additional steps than are required with the current invention. Furthermore, the traditional method of displacing soil requires both removing soil before planting and replacing the soil after planting. These additional steps take additional time and can create additional mess.

### SUMMARY OF THE INVENTION

It is an object of this invention to provide a hand-held gardening tool having a wedged shaped portion, and a handle having a generally knob shape.

It is another object of this invention to provide a gardening tool having a wedged shaped portion that allows the user to plant by inserting the wedge shaped portion into the ground once, gripping the handle from the top and rocking the tool back and forth and/or side to side to create a space in the soil for a plant to be planted with minimal or no hand or wrist motion, reducing fatigue or injury.

It is another object of this invention to provide a gardening tool that allows a plant to be planted without removing any soil, by displacing the soil with minimal disturbance to the surrounding plants, even plants in close proximity, allowing closer planting in a shorter period of time than the traditional method of using a trowel or other gardening tool to dig a hole.

It is still another object of this invention to provide a gardening tool that allows a plant to be planted in a manner that disturbs as few of the surrounding root systems from other plants as possible by pushing away surrounding root systems and the soil in the area of the new hole rather than cutting through the roots in a large area and potentially removing them along with the soil.

### BRIEF DESCRIPTION OF THE DRAWINGS

FIG. 1 is a perspective view of the gardening tool of the invention showing one tapered side and one face of the tool.

FIG. 2 is a side view of the gardening tool of the invention showing one of the tapered sides of the tool.

FIG. 3 is a front side view of the gardening tool of the invention, showing the front face of the tool.

FIG. 4 is a top view from the handle of the gardening tool device.

FIG. 5 shows the gardening tool in use displacing soil and nearby roots from other plants and forming a hole.

### DETAILED DESCRIPTION

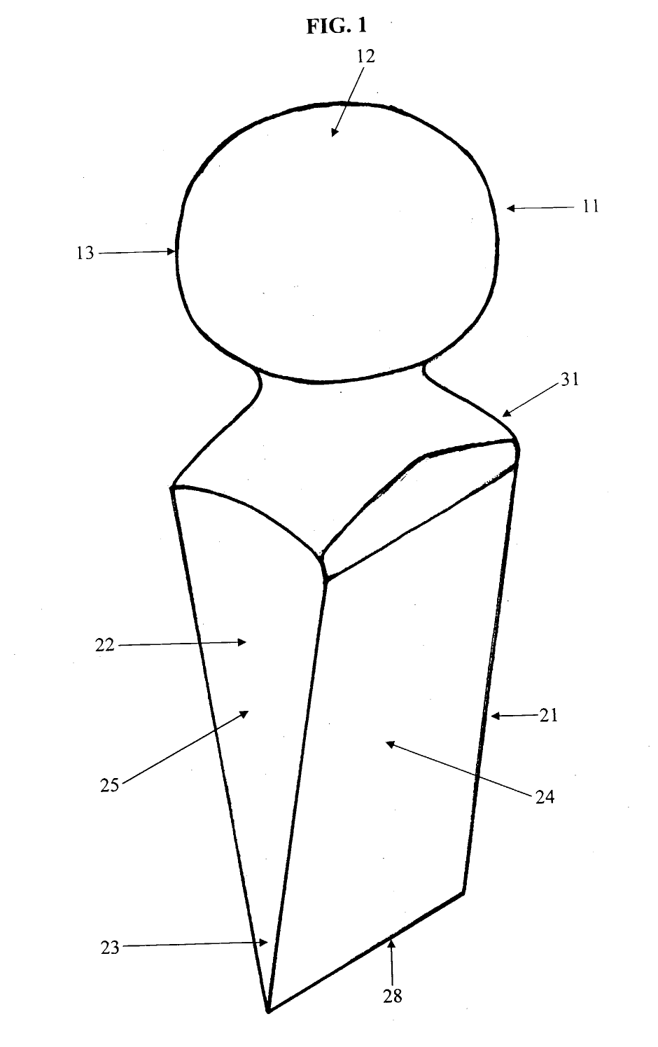

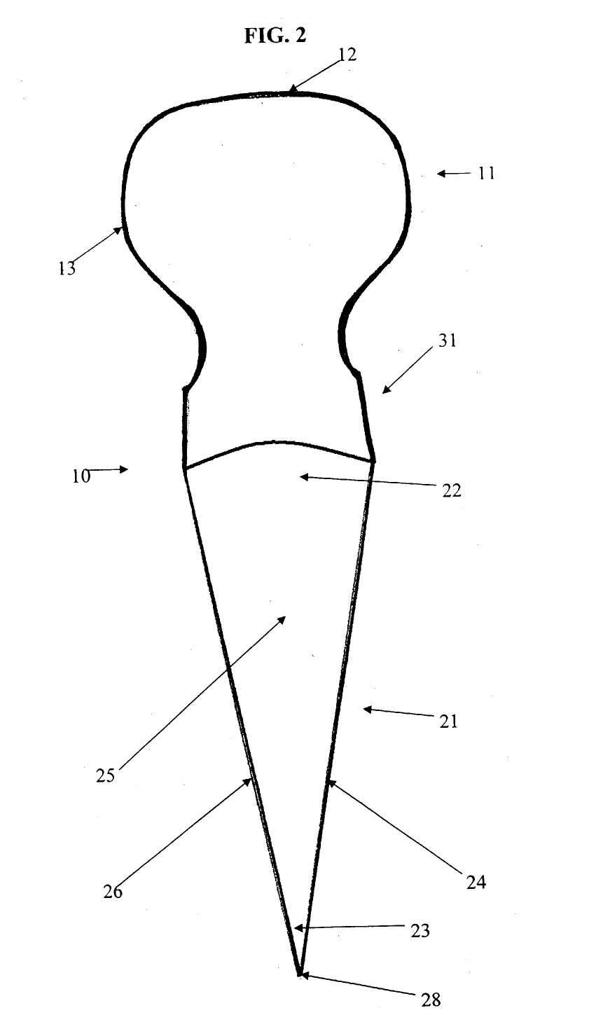

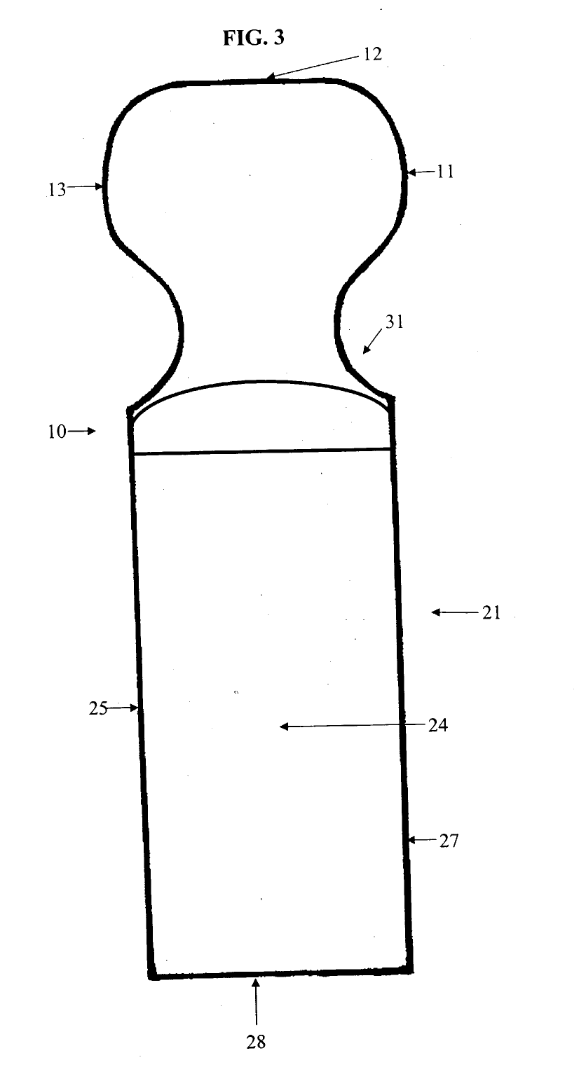

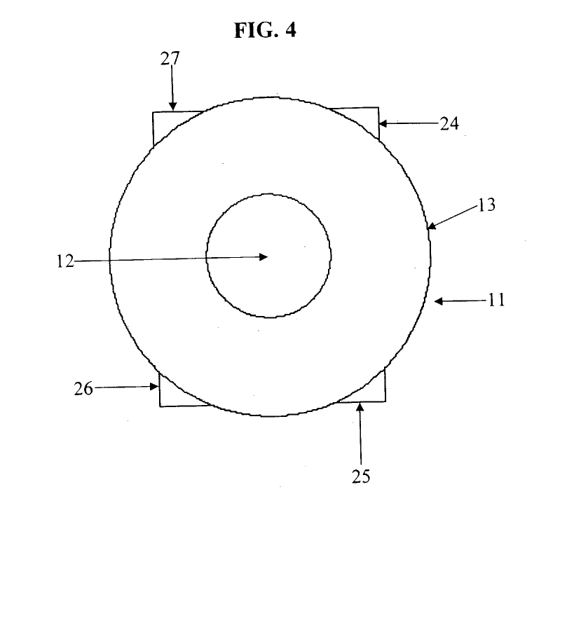

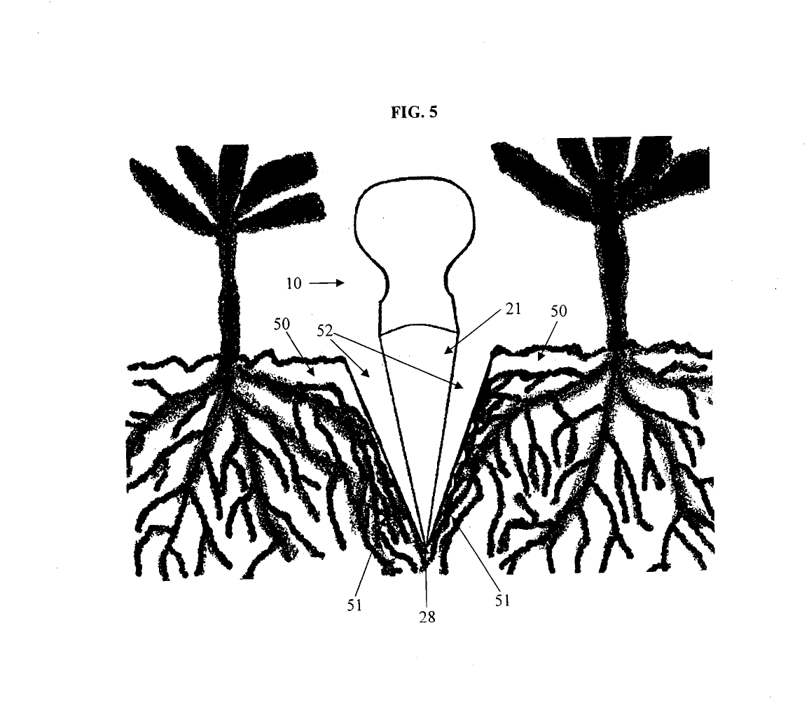

The invention consists of hand-held gardening tool 10 with a generally knob shaped handle 11 connected to a wedged shaped portion 21. FIG. 1 shows a perspective view of the gardening tool 10 of the invention. FIG. 2 shows the side view of the gardening tool 10 with the handle 11 connected to the wedge shaped portion 21. FIG. 3 shows another side view of the gardening tool 10, handle 11, and wedge shaped portion 21. FIG. 4 shows a top view of the gardening tool 10 of the invention from the top of the handle 11. FIG. 5 shows the gardening tool in use displacing soil and nearby roots from other plants and forming a hole.

The handle 11 is generally knob shaped so as to allow the user to grip the tool ergonomically from the top of the knob with a hand, as if grasping a door knob. In the preferred embodiment, the shape of the handle 11 is similar to a door knob as illustrated in FIGS. 1, 2, 3, and 4. Also, in the preferred embodiment, there is a somewhat flattened, rounded, smooth portion 12 that rests generally within the palm of a user's hand while the user's fingers can simultaneously grasp the generally rounded portion 13. The handle 11 can have any variety of knob shapes, such as, by way of example only, a flattened disc shape or a rounded ball shape. Preferably the handle 11 has an ergonomic shape that allows a user to grip the knob comfortably with his or her hand with minimal strain to the hand and wrist. The shape of the knob when viewed from the top side, as seen in FIG. 4, can be circular, oval, octagonal, heart shaped or another ornamental shape. A preferred shape will allow at least a portion of the user's palm to rest comfortably at the top of the handle 11.

In a preferred embodiment, the gardening tool 10 is made from one piece of solid high-impact plastic, having a handle 11, a wedge shaped portion 21, and a transition stem 31 that connects the handle 11 to the wedge shaped portion 21. The gardening tool 10 is preferably made from a one piece construction using solid resin or polymer, but the gardening tool may be assembled using multiple pieces, and any other solid material, or combination of materials, such as wood or metal, may also be used. Thus, the gardening tool 10 can comprise separate pieces that are fixedly attached in a manner known to those in the art, such as by using screws, rivets, or other fastening devices, welding, or using an appropriate adhesive. The gardening tool preferably can be colored so that it contrasts with normal colors found in a garden, such as, for example, bright yellow, so that the tool can be easily located if placed on the ground or in a garden bed.

The wedge shaped portion 21 is connected to the handle 11. In the preferred embodiment, the wedge shaped portion 21 has flat planar surfaces on four sides and forms a wedge shape with a thick portion 22 and a thin portion 23 as illustrated by FIG. 2. The wedge shaped portion is formed by having a front face 24, a first tapered side portion 25, a back face 26, and a second tapered side portion 27, which all meet to form a blade 28, as shown in FIGS. 1, 2 and 3. The blade 28 is an edge that can have any number of edge profile shapes, such as a rounded shape, a pointed shape, a substantially straight shape or any other number of shapes, and can have any level of sharpness from relatively dull to, as preferred relatively sharp. The front face 24, the first tapered side portion 25, the back face 26, and the second tapered side portion 27 can also have curved rather than flat planar surfaces, either in a convex or concave manner. The handle 11 is located proximate to the end of the thick portion 22 of the wedge shaped portion 21.

The shape of the wedge shaped portion 21 allows the user to insert the wedge shaped portion 21 in loose soil in one motion by gripping the handle 11 and pushing the thin portion 23 of the wedge shaped portion 21 into the soil to the necessary depth. Thereafter the user grips the handle 11 and rocks the gardening tool 10 back and forth and/or side to side to displace the soil, creating a space for the object to be planted without removing the soil or roots from other plants that may be in the area. The rocking motion is quicker and less fatiguing to the user's wrist and hand than the twisting motion required for removal of soil with a trowel or other known gardening tools. FIG. 5 shows the wedge shaped portion 21 of gardening tool 10 after being inserted in soil 50 and rocked back and forth. As shown in FIG. 5, by rocking the wedge shaped portion 21 of gardening tool 10, the roots from nearby plants are displaced but not cut substantially in the area 51 where the surrounding plants' roots have grown and a hole 52 is created for planting. The only roots cut by this method are those that are directly in line with the blade 28 of the wedge shaped portion 21 when the wedge shaped portion 21 is inserted into the soil. Otherwise, any roots will simply be pushed out of the way rather than cut or removed from the soil as with traditional methods, such as using a trowel to remove soil to form a hole. Also, by displacing soil with the present invention, rather than removing soil as with prior art gardening tools, planting can be accomplished more quickly, because the soil does not need to be relocated such as by replacing it. Because relocation of removed soil can often result in a mess, planting with the present invention also can minimize or eliminate the mess associated with planting using prior art gardening tools.

If the gardening tool 10 is made from a single piece of material, the precise shape of the transition stem 31 connecting the handle 11 to the wedged shaped portion 21 is unimportant so long as the handle 11 and the wedge shaped portion 21 are solidly connected and the transition stem 31 does not interfere with the user's ability to grasp the rounded portion 12 with his or her fingers.

In one preferred embodiment, the gardening tool 10 is approximately 5 to 9, but more preferably approximately 7 inches long from the top of the top of the handle 11 to the blade 28 of the wedge shaped portion 21, with the wedge shaped portion 21 being approximately 3 to 6, but more preferably 4½ inches long, the front face 24 and the back face 26 and blade 28 of the wedge shaped portion 21 being approximately 1½ to 2½, but more preferably 2 inches wide, and the widest portion of the first tapered side 25 and the second tapered side 27 of the wedge shaped portion 21 being approximately 1 to 2½, but more preferably 1½ inches wide. The handle 11 and the transition stem 31 together measure approximately 2½ inches in length and the handle 11 is approximately 2¼ inches in diameter, in one preferred embodiment. This one preferred embodiment is of a size that allows a user to plant easily individual plant plugs from 12-0-4 or similar flower flats. The precise size of the gardening tool of the invention is unimportant and can be as large or as small as needed to plant a particular- sized plant.

The features and advantages of the invention are apparent from the detailed specification and it is intended by the appended claims to cover all such features and advantages of the invention which fall within the scope of the invention. Since numerous modifications and variations will readily occur to those skilled in the art, it is not desired to limit the invention to the exact construction and operation illustrated and described, and therefore, all suitable modifications and equivalents fall within the scope of the invention.

What is claimed:

1. A gardening tool comprising:
a handle;
a wedge attached to said handle;
said wedge further comprising a front face, a rear face, a first tapered side portion, and a second tapered side portion, said first and second tapered side portions each having a thicker end and a thinner end wherein said thicker end of said tapered portions are more proximate to said handle than said thinner ends, said thinner ends of said first and second tapered portions and said front end rear faces of said wedge terminating in a blade.

2. The gardening tool of claim 1 wherein said handle is substantially knob shaped.

3. The gardening tool of claim 2 wherein said knob shaped handle is designed to fit within the palm of a human hand.

4. The gardening tool of claim 1 wherein said attachment of said handle to said wedge is a fixed attachment.

5. The gardening tool of claim 2 wherein said handle is attached to said wedge by way of a transition stem between said handle and said wedge.

6. The gardening tool of claim 5 wherein said handle is fixedly attached to said transition stem, and said transition stem is fixedly attached to said wedge.

7. The gardening tool of claim 1 wherein said blade has a substantially straight profile.

8. The gardening tool of claim 6 wherein said blade has a substantially straight profile.

9. The gardening tool of claim 8 wherein said gardening tool is a one-piece construction.

10. The gardening tool of claim 9 wherein the gardening tool is made of molded, impact resistant resin.

11. The gardening tool of claim 2 wherein said substantially knob shaped handle has a top portion, a middle portion, and a bottom portion, said bottom portion of said substantially knob shaped handle being most proximate to said wedge, said top portion of said substantially knob shaped handle being opposite to said bottom portion of said substantially knob shaped handle and less proximate to said wedge, and said middle portion of said substantially knob shaped handle being located between said top and bottom portions of said substantially knob shaped handle, said top portion of said substantially knob shaped handle having a substantially flattened shape, and said middle portion of said substantially knob shaped handle having substantially circular cross sections.

12. The gardening tool of claim 5 wherein said substantially knob shaped handle has a top portion, a middle portion, and a bottom portion, said bottom portion of said substantially knob shaped handle being most proximate to said wedge, said top portion of said substantially knob shaped handle being opposite said bottom portion of said substantially knob shaped handle and less proximate to said wedge, and said middle portion of said substantially knob shaped handle being located between said top and bottom portions of said substantially knob shaped handle, said top portion of said substantially knob shaped handle having a substantially flattened shape, and said middle portion of said substantially knob shaped handle having substantially circular cross sections.

13. The gardening tool of claim 6 wherein said first and second tapered side portions are substantially flat planar surfaces.

14. The gardening tool of claim 13 wherein said first and second tapered side portions are substantially parallel to each other.

15. The gardening tool of claim 14 wherein said front and rear faces are substantially flat planar surfaces.

16. The gardening tool of claim 15 wherein said blade has a substantially straight profile.

17. The gardening tool of claim 16 wherein said gardening tool is a one-piece construction made of impact resistant resin.

18. The gardening tool of claim 17 wherein said blade is between 1.5 and 2.5 inches in width.

19. The gardening tool of claim 18 wherein said wedge is between 3 to 6 inches in length.

20. The gardening tool of claim 19 wherein said thicker ends of said first and second tapered portions are between 1 and 2½ inches in width.
